(19) United States
(12) Patent Application Publication
(10) Pub. No.: US 2003/0230522 A1
(43) Pub. Date: Dec. 18, 2003

(54) Portable high-pressure washing and rinsing system producing and using ultrapure ultrasoft reverse osmosis water

(76) Inventor: Augustin Pavel, Fallbrook, CA (US)

Correspondence Address: FUESS & DAVIDENAS, Suite II-G, 10951 Sorrento Valley Road, San Diego, CA, 92121-1613, US

(21) Appl. No.: 10/174,240

(22) Filed: Jun. 17, 2002

(51) Int. Cl. B01D 35/14; B01D 63/00

(52) U.S. Cl. 210/137; 134/109; 210/241; 210/258; 210/259; 210/335; 210/321.65

(57) ABSTRACT

A cart, preferably welded aluminum, supports both vertically and horizontally for rolling and transport a reverse osmosis and pressure pumping system. In the system preferably (i) two series-flow-connected pre-filters of, nominally, 5 micron sediment and KDF carbon types, that are preferably series-flow-connected with (ii) an optional anti-scaling device, both receive and pre-filter input water. Pressure of the pre-filtered input water is boosted to, nominally 150 p.s.i., in a first pump of nominal 3 g.p.m. flow capacity before being supplied to preferably 3 series-flow-connected RO membrane filters, each typically with a membrane of 2½″×40″ and a flow capacity of 1,300 gallons per day. Water purified to, preferably, less than 10 and nominally 7 ppm Total Dissolved Solids (TDS), is boosted in a second, 2 gpm, pump to, preferably, about 1000 p.s.i., with a nominal 1 gpm waste water going to drain and/or for recycling. Both pumps are preferably powered by opposite ends of the same shaft of a ½ hp., 135 amp. 110 v.a.c. electric motor. Filters will commonly last 6-12 months, and membranes 3-5 years, dependent upon use—normally 100+ sprayings/washings of vehicles, motorcyles, buildings, windows and the like per day—and upon water quality. As well as spotless rinsing, the sprayed RO water is so pure so as to act well as a solvent, permitting soap-less cleaning.

### BACKGROUND OF THE INVENTION

1. Field of the Invention

The present invention relates in general to high-pressure water washing and rinsing systems, particularly for vehicles, motorcycles, boats, buildings and other substantial objects.

More particularly, the present invention relates to a portable high-pressure washing and rinsing system which both makes and uses reverse osmosis to continuously produce ultrapure ultrasoft purified reverse osmosis water for both washing and rinsing.

2. Description of the Prior Art

2.1 Specific Previous Use of RO Water in Washing and Rinsing Systems

It is known to use purified reverse osmosis (RO) water in both washing and rinsing, including for the washing and rinsing of vehicles, motorcycles, boats, buildings and other substantial objects.

U.S. Pat. No. 4,029,114 to Wiltrout for a BACK FILTER AUTOMATIC VEHICLE WASH WATER RECLAIM SYSTEM concerns a vehicle wash water reclamation system receiving drain water from an automatic car wash bay. A number of pairs of back wash filter tanks which are connected together in a manner that first provides for filter flow in a forward direction through a pair of such tanks and then, second, provides for reverse flow of the entire flow volume in reverse direction through a single filtering tank to back wash this filtering tank.

U.S. Pat. No. 5,040,485 to Bailey, et al., for an AUTOMATIC CAR WASH SYSTEM concerns a simplified automatic car wash system having a linear trolley suspended from the upper structure of a car wash building and a cross trolley transversely mounted thereto. A spray arm is rotatably mounted to a glider plate on the cross trolley and used to deliver soap and water to an automobile. The spray arm is the only cleaning apparatus used, there being no need for rotating brushes and the like. As such, the only elements which come and in contact with the automobile during a car wash, are soap and water. It is recognized as preferred that the wash should include applying a spot free rinse of water produced by treatment in a reverse osmosis filter.

U.S. Pat. No. 5,122,265 to Mora, et al., for a COMPACT REVERSE OSMOSIS SYSTEM WITH COLD WATER FLUSH concerns a reverse osmosis purification system operated at a ratio in the range of approximately 1:1 to 2:1 waste water to product water. The system uses the cold water outlet and a cold water path which extends through the RO membrane to remove non-migrating particles trapped on the outside of the reverse osmosis membrane, therein removing salts from the membrane and prolonging the life of the membrane despite a low brine to pure water ratio.

U.S. Pat. No. 5,147,532 to Leek, Jr. for a DOMESTIC GREY WATER PURIFIER USING DIVERTER AND UV FILTER TREATER WITH PREHEATER teaches oppositely to the present invention. The Leek, Jr. invention concerns a water purification system for treating grey water from household appliances such as baths, showers, vanity basins and a washing machine. Each of these appliances has branch-off pipes from their usual drain pipes, which branch-off pipes lead to a storage tank. The recovered branched-off water is filtered by a screen filter and then circulated by a pump in series to a heater. The system also includes a sediment filter, a carbon filter, a color filter, an ultraviolet radiation unit, and, via a shut-off valve, a storage tank. The purified grey water can be used for car-washing, and garden and lawn irrigation. The system is stated to be retrofitable to an existing home or installable in a new home.

U.S. Pat. No. 5,160,430 to Gasser, et al., for a CAR WASH SYSTEM USING REVERSE OSMOSIS CONCENTRATE FOR INITIAL RINSING AND PERMEATE FOR FINAL RINSING describes a rollover type car wash and rinse machine which uses permeate from a reverse osmosis unit for a final rinse operation. The machine is operator controlled to wash and initially rinse cars with a spray arch using raw water and concentrate from the reverse osmosis unit. A final rinse can then be performed with a second spray arch using permeate alone, and only after a wash and initial rinse has been performed.

As is related in this U.S. Pat. No. 5,160,430 to Gasser, et al., regardless of how a car or like object is washed, the final rinse water normally contains minerals and impurities which leave water stains or residue marks upon evaporation. Traditionally, cars have been manually dry wiped with an absorbent cloth to avoid “spotting”.

Many automatic car wash systems before that of Gasser, et al.—and that of present invention—have employed drying devices which attempted to eliminate or reduce the manpower needed to physically hand dry the car. Drying has most commonly been accomplished by a series of blowers which supply relatively high pressure air to blow away most of the rinse water and accelerate the evaporation of smaller droplets. These systems are inefficient because enough water is left on the car to require a worker to perform a final dry wipe with a cloth to avoid leaving water stains. In addition, the blowers consume large amounts of electrical energy.

Other prior art automatic drying devices for removing rinse water from cars include devices that sweep or draw absorbent materials across the wet surfaces. These devices are not always effective and are subject to accumulations of dirt and grime in the absorbent materials, requiring frequent removal, laundering and replacement.

In an effort to eliminate the need for hand drying or automatic drying devices, the reverse osmosis principle is employed to purify the rinse water and remove the impurities which leave “spotting” or water stains upon evaporation. The purified reverse osmosis water dries spotless, eliminating the need for manual or automatic drying. Despite the benefits obtained by using reverse osmosis rinse water in car wash systems, Gasser, et al., found the devices in use prior to their invention to possess several drawbacks which reduced their effectiveness.

One drawback resulted from the fact that purifying water through the reverse osmosis process produces approximately one gallon of mineral-rich concentrate for each gallon of pure water produced. A typical final rinse operation requires nine to ten gallons of pure water. As a result, nine to ten gallons of mineral-rich concentrate normally become waste water which is discharged through the sewage system. Customers complain about the high levels of water consumption and the large amount of waste water which must be discharged down the sewer.

Another drawback found by Gasser, et al., was that when previous systems were not in operation for extended periods, such as overnight or during the weekends, the membrane in the reverse osmosis unit became contaminated with bacteria in a short period of time. This reduced the life of the membrane and results in high replacement and maintenance costs, as well as system inefficiencies.

Yet another drawback found by Gasser, et al., was occasioned by the fact that fixed car washing systems in use previous to their invention counted each wash, initial rinse, and final rinse step in the operation as one cycle. Payment schedules were typically determined on the basis of the number of complete cycle operations. Thus if a car is merely dusty and the operator chooses to use only the final rinse operation, the machine owner was not paid because a full cycle operation has not been used. Secondly, since the final rinse operation was typically used more frequently than the full cycle for which payment is received, the life expectancy of the component parts of the reverse osmosis system for full cycle operation was correspondingly reduced and the system owner's)s') costs were increased. Finally, the system owners were typically unable to accurately monitor the number of final rinse operations which have been performed and, as a result, are unable to adhere to the desired maintenance schedule.

In view of these considerations, the improved car wash system of Gasser, et al., employs reverse osmosis only as a final rinse while greatly reducing the amount of waste water. This arrangement prolongs membrane life in the reverse osmosis module.

For economic reasons, Gasser, et al., show a reverse osmosis car wash system which requires that the wash and initial rinse operations be performed before the final, pure water rinse can be effected. The Gasser, et al. invention is embodied in a system including a roll-over type machine which employs a wash, an initial rinse, and a final rinse performed with reverse osmosis purified water. A system controller prevents the reverse osmosis final rinse operation from being performed unless the car wash system first performs the wash and initial rinse (with unpurified water) operations. The system does not allow the final rinse operation to be performed as an independent operation.

The Gasser, et al., car wash system also reclaims and reuses the concentrate, or mineral-rich water, which is a by-product of the reverse osmosis process. The water is reused in the next wash, or in the initial rinse operation.

The Gasser, et al., system also uses reverse osmosis purified water to automatically flush concentrated solids and bacteria from the membrane in the reverse osmosis module after a predetermined period of time. When the membrane is not functioning, such as overnight and on weekends, the membrane housing is filled with pure, reverse osmosis water to prevent membrane bacteria growth. More specifically, during the final rinse operation the final rinse system controller automatically signals the raw water pump to send more water through the reverse osmosis module to replenish the pure water taken from the holding tank during the final rinse operation. When the pure water level reaches the level of a float switch located near the top of the pure water holding tank, the system controller commands the raw water pump to deliver enough water to produce three to four more gallons of pure water, at which point the pump is shut off. At the same time that the float switch communicates with the system controller to call for the additional feed (raw) water, the switch triggers a time delay in the controller. If the final rinse system is not used for a predetermined period of time, the system controller causes the extra three to four gallons of pure water to be pumped through the reverse osmosis module. The reverse osmosis membrane is flushed and then immersed in pure water when the system is not in operation, typically overnight or on weekends.

U.S. Pat. No. 5,255,695 to Downey for a VEHICLE WASHING APPARATUS explains that vehicle washing apparatuses through which an entire vehicle—such as a passenger automobile—is pulled or driven are well known. Many of these apparatuses employ rotating brushes or brush-type rollers which make contact with the vehicle as part of the cleaning process. Other types of systems utilize spraying arrangements which apply a sequence of detergents and rinses to remove grease, dirt and other grime. Still other types of systems may use a combination of both spray arrangements and brushes.

Vehicle washing apparatuses that solely use spray arrangements are particularly popular because they do not scratch or mar the finish of the vehicle due to abrasive contact by brushes, rags or other frictional devices. The sprayed washing fluids typically include a presoak fluid and a soap that chemically loosen and remove dirt from the surface of the vehicle. A high pressure rinse is then applied to remove any remaining traces of dirt and the presoak and soap fluids. The rinse fluid may include softeners and surface tension relievers or surfactants to prevent spotting on the vehicle after washing. In addition, hot wax solutions in fluid form may be applied to the vehicle after cleaning. It is recognized that a final rinse consisting of distilled or RO (reverse osmosis) water may be applied last.

The particular vehicle washing apparatus of Downey has U-shaped arches through which a vehicle passes during a washing operation. The arches contain a plurality of pivotally mounted conduits and spray nozzles through which various washing fluids are pumped. During a washing operation the conduits and nozzles are pivotally rotated about the conduit axes in an oscillatory motion that sweeps spray from the nozzles in an arc over a vehicle to be washed. Different washing fluids are applied to the vehicle in a sequence of operations that wash and rinse all sides of the vehicle. The apparatus may be used with all types of vehicles including trucks, buses, railway cars and locomotives as well as passenger automobiles.

U.S. Pat. Nos. 5,266,123 and 5,363,865 to Brand for a VEHICLE WASHING MACHINE concern a washing apparatus suited for use in washing outside surfaces of vehicles. Fluid is conducted along a conduit that is mounted to a support structure so as to permit selected displacements thereof along a longitudinal axis of the conduit and selected rotations thereof about the longitudinal axis. The fluid conducted through the conduit can be conducted through at least one of a number of nozzles that are mounted to the conduit. The conduit is selectively reciprocated along the longitudinal axis by a first driving device. In addition, the conduit is rotated about the longitudinal axis by a second driving device. As the conduit is displaced both about and along the longitudinal axis, the fluid forced through the nozzle is directed toward the outside surface of an object to be washed.

It is described to add various chemicals to the fluid flowing in the wash pipes by chemical pumps, a low pressure manifold, low pressure solenoids and injectors. One chemical pump provides reverse osmosis water, at low pressure, from a reverse osmosis water supply through a conduit to the low pressure manifold. The low pressure solenoids are capable of blocking the flow of fluid from each of the outlets of manifold, and each of these solenoids is under control of the programmable logic controller. A pressure gauge is used to monitor the fluid pressure in the low pressure manifold.

U.S. Pat. No. 5,413,128 to Butts for an AUTOMATIC PERSONAL CAR WASHING METHOD AND APPARATUS concerns a personal automatic car wash which includes an enclosure for the car. A movable fluid dispensing assembly is mounted on a track in the enclosure so that fluids can be dispensed to the surfaces of a stationary car situated within the enclosure. The fluid dispensing assembly is driven by a drive motor longitudinally back and forth about the car while fluids are dispensed to the car. Under computer control, the fluid dispensing assembly sequentially sprays a heated soap/water mixture under relatively low pressure and then a heated rinse water under relatively high pressure to clean the car. A steam-bath like atmosphere is thus provided which enhances the removal of dirt from the car and the cleaning of the car without the use of abrasive cleansers. It is described that a spot free water rinse is applied to the car to further clean the car.

U.S. Pat. No. 5,647,977 to Arnaud for A METHOD AND APPARATUS FOR REMOVING CONTAMINANTS FROM INDUSTRIAL WASTE WATER is relevant to the present invention for disclosing a system is provided for removing impurities anticipated to be found in industrial waste water, which system is particularly well suited for waste water systems such as those used for laundry or vehicle washing operations. The system includes aeration, mixing/flocculating, and contact media mechanisms to remove suspended solids, hydrocarbons, organic materials and undesired dissolved minerals from the treated water.

2.2 The Theory and Practice of the Use of Purified Water in Washing and in “Spotless” Rinsing

The article “Incoming Water Quality: How Pure Does It Need To Be?” by Rick Reynolds appearing in “The Magazine for Industrial Metal Cleaning” at pages 20-21, for November, 2000, discusses the often necessary decision as to what is the best grade of water to use when cleaning. At least in industrial cleaning operations, Mr. Reynolds asserts that a wrong decision can prove quite costly, both from a financial standpoint and due to substandard results and equipment damage. Some cleaning operations use tap water; others use ultrapure grades. The issue—whether parts or entire vehicles are being cleaned—is how to determine what grade of water is appropriate for the application.

Water quality is a measure of the level and significance of any substance (other than pure H₂O) found in a water sample. The potential severity of a contaminant depends on the applications in which the water will be used. For example, bacteria may not matter in some applications but dissolved silica will.

There are numerous methods for determining water quality, and each depends on how critical the data is to the application.

The most frequently used method of determining water purity is to measure conductivity or resistivity. This will be seen to be the convenient measure of water purity used in the system of the present invention. Conductivity is a numerical value determined by a solution's potential to carry an electrical current. This potential is dependent on the dissolved chemical species present in that solution (pure water is essentially nonconductive) and their relative concentration and valence.

Water hardness is another method of analyzing water. This is a measure of the calcium and magnesium content of water and is most often expressed in terms of parts per million (ppm) of calcium carbonate.

There are a number of instrumental methods for measuring water quality. These can be simple, convenient, and informative—especially if the instrumentation is integrated into the water system, as it will seen to be in the system of the present invention. If, however, samples must be sent to an independent analytical laboratory, the analyses can become quite costly. Many instrumental techniques, such as atomic absorption (AA) or inductively coupled plasma (ICP), can return levels of anions, cations, and elements as low as parts per billion. In general measurements should be made only as necessary to keep the process cost-efficient—which will be seen to be the case in the present invention.

Several problem contaminants to realizing pure water can exist.

Ionic contaminants are most likely culprits in degrading the purity of water. Cationic contaminants are primarily metals such as magnesium (Mg₂⁺), calcium (Ca₂⁺), iron (Fe₂⁺, Fe₃⁺), and, for some applications, sodium (Na⁺) and potassium (K⁺). Other ions that can be common at trace levels in tap water (and at higher levels in waste water) include copper (Cu₁⁺, Cu₂⁺), manganese (Mn₂⁺, Mn₃⁺, Mn₄⁺, Mn₇⁺), aluminum (Al₃⁺), tin (Sn₂⁺, Sn₄+), nickel (Ni₂⁺, Ni₃⁺), zinc (Zn₂⁺), lead (Pb₂⁺, Pb₄⁺), and silver (Ag⁺).

All of these contaminants have conductive effects and can have dangerous consequences if left as residues on metal substrates. All of the metals except sodium and potassium will form insoluble precipitates and solids when they contact anions like carbonates, oxides, borates, and silicates.

These insoluble salts can cause a number of problems. They have an affinity for many surfaces and contribute to the formation of “water spots” upon drying. Also, these precipitates tend to clog pumps, membranes, and nozzles. They contribute heavily to aesthetic equipment scale that must be removed periodically.

Many of the anions that form these insoluble species are introduced through the use of builders, corrosion inhibitors, and some surfactants in aqueous cleaning agents. When employing such chemistries, it is paramount that good quality water be used. Aside from the external effects mentioned above, hardness ions can cause cleaning agents to lose their cleaning power. By binding with certain active materials, the ions often can disable some formulas and in some cases lead to the creation of foam builders and stabilizers.

Anionic contaminants do not promise the same disabling effects as cationic contaminants. Some anions, like chlorides (Cl⁻), have the potential to cause corrosion. However, most scales and precipitates that form due to cationic contamination drag an anionic half along with them. By themselves, most cations and anions are free-rinsing; the trouble occurs when they meet each other and combine to form insoluble and tenacious compounds.

Silica—otherwise known as silicon dioxide (SiO₂)—occurs naturally as sand, quartz, and other related materials. In water, it occurs mainly as a dispersed, insoluble colloid or particle. The main trouble with silica is that it has a strong affinity for surfaces and produces a very tenacious scale Silica also can form a problematic haze on glass or polished surfaces. Unless an extremely well-formulated surfactant is employed, silica can only be removed by either an acid (which converts it into soluble silicic acid) or an alkaline material (which converts it into a soluble silicate).

Still other contaminants can impact the purity of water. These include miscellaneous dissolved and undissolved solids, like dust or dirt, which can lead to general particulate contamination. Bacteria can cause odors if exposed to a food source and pathogenic concerns if left on medical devices. For most cleaning applications, the occurrence and effects of these species are minimal.

The system of the present invention will be seen to substantially completely finesse the problem of how much contamination, and which contaminants, are tolerable by the simple expedient of economically getting rid of virtually all contamination, producing (and exclusively using) ultrasoft and ultrapure water.

The reverse osmosis used in the present invention to realize water treatment should be compared with other methods. An method should by which water is treated to deliver optimum quality should be chosen depending upon the application. The present invention will be seen to choose—with supportive rationale and justification—to purify water used for the washing and rinsing of vehicles and the like to a much, much better standard than is common in the prior art, and to so purify the water continuously, and for all washing and all rinsing purposes, and not just for final rinsing.

There are several methods for treating incoming water include conventional filtration, also referred to as macrofiltration. Conventional filtration covers a particle size range from about 1 micron and up. Common techniques involve bag filters and depth filters; however, sand filters and strainers are used also.

Like macrofiltration, membrane technologies serve the purpose of separating contamination from the water. Microfiltration, ultrafiltration, nanofiltration, and reverse osmosis are all membrane technologies with respectively descending pore sizes. They are tailored to be most effective within certain contaminant size ranges. This is done via engineering specific pore sizes in the membrane material.

Ion exchange is used to remove ionic material from water. Ion exchange will retain cations (e.g., magnesium and calcium) and anions (e.g., chlorides and phosphates) when the water flows through cationic and anionic exchange resins, respectively.

Activated carbon can be used to adsorb and remove organic materials and residual chlorine. Carbon generally is placed downstream from skimming and filtration processes to minimize its exposure to unnecessary contamination.

Ultraviolet radiation, also called catalytic oxidation, can be used in lieu of carbon to remove organic residues.

When determining water purity requirements for any cleaning system, it must be considered how contamination will influence the object cleaned, the cleaning equipment(s), and the cleaning results. Cleaning applications require a certain degree of water purity (excluding those that clean and/or rinse using non-aqueous methods). To save money on purified water one should first understand how water quality impacts a specific cleaning task and cleaning system. A line should be drawn, and a course plotted, between unnecessary purity and harmful contamination.

Water quality may be a small factor within the grand scheme of a cleaning operation. Breaking down the system into basic components provides the true cost efficiency of the system as a whole. It is possible to empirically measure and determine if the quality water does make a difference, from both a cost standpoint and in terms of productivity.

2.3 KDF Material

The present invention will be seen to incorporate a filter which preferably contains the well-known KDF filtration material available from KDF Fluid Treatment, Inc., KDF Fluid Treatment, Inc. 1500 KDF Drive, Three Rivers, Mich. 49093-9287, USA.

The KDF process media are high-purity copper-zinc granules used in a number of pre-treatment, primary treatment, and waste water treatment applications. KDF media supplement or replace alternative technologies in order to dramatically extend life of a filtration system, control heavy metals and microorganisms, lower total cost, and decrease maintenance. KDF process media work to reduce or remove chlorine, iron, hydrogen sulfide, lead, mercury, calcium carbonate, magnesium, chromium, bacteria, algae, and fungi.

KDF media use an old process in a new way: the oxidation and reduction of ions, known as redox. In short, the redox process works by exchanging electrons with contaminants. This give and take of electrons converts many harmful contaminants into harmless components, such as chlorine to chloride. Other contaminants, including heavy metals, bond to the KDF media, which greatly reduces or virtually eliminates these substances.

KDF process media control microorganisms in two ways. The first is a by-product of redox; the exchange of electrons sets up an electrolytic field in which most microorganisms can't survive. Second, the process of forming hydroxyl radicals and peroxides from some of the water molecules interferes with the microorganisms' ability to function.

The KDF media and process are the subject of U.S. Pat. Nos. 5,951,869, 5,833,859, 5,599,454, 5,510,034, 5,433,856, 5,314,623, 5,275,737, 5,269,932, 5,198,118, 5,135,654, and 5,122,274 all for a METHOD OF TREATING FLUIDS; U.S. Pat. No. 6,197,204 for ZINC OXIDE FLUID TREATMENT; U.S. Pat. No. 5,837,134 for SCALE REDUCTION; and U.S. Pat. No. 5,415,770 for an APPARATUS FOR TREATING FLUIDS—ball assigned to what is presently (circa 2002) KDF Fluid Treatment, Inc. (Constantine, Mich.).

Of these, the seminal U.S. Pat. No. 5,122,274 to Heskett, and assigned to KDF Fluid Treatment, Inc., Constantine, Mich., U.S.A., for a METHOD OF TREATING FLUIDS is exemplary. A method for treating fluid to remove hydrogen sulfide and sulfur dioxide is disclosed. The method includes passing fluid containing the hydrogen sulfide and/or sulfur dioxide through a bed of metal particulate matter. The metal particulate matter is preferably chosen from metals having favorable redox potentials relative to the redox potentials of these undesirable constituents so as to establish conditions for spontaneous oxidation and reduction reactions between the undesirable constituents and the metal particles. It is these materials—primarily the aforementioned copper and zinc granules that constitute the KDF media preferred in the present invention. The contents of the predecessor patents are incorporated herein by reference.

2.4 Catalytic Water Conditioners

The present invention uses a device called an “anti-scaling device” that is analogous, and similar, to devices called “catalytic water conditioners”. Operation of the present invention in no way depends upon the anti-scaling device, which is strictly optional, but invention benefits by the incorporation of at least one such anti-scaling device which is of new and original design.

Previous catalytic water conditioners, as hereinafter explained, have been promoted as substitutes for chemical water softeners and water softening. For those totally unfamiliar with these catalytic water conditioning devices, most consist of simple metal elements contained within flow channels, or pipes.

Before even discussing these devices it should be known that, despite existing for over forty years, catalytic water conditioners are still, circa 2002, exceedingly controversial. This is likely due to several factors. First, these devices are not uniformly and reliably effective under all conditions of water hardness, pressure and flow. Accordingly, there are no firm guidelines on how to apply catalytic water conditioners. Second, despite being relatively economical of construction, catalytic water conditioners—which the inventor of the present invention believes do in fact possess certain desirable functionality—have been sold and promoted at exorbitant prices, bringing disrepute upon the entire industry making and selling these devices.

Third, and likely most important, there is no generally accepted theory of why catalytic water conditioners work, or might work. Many water treatment professionals seem willing to credit that, by inducing turbulence within flowing water, a catalytic water conditioner might well have a positive beneficial effect on the deposition of scale in the flow conduit for some feet or yards downstream of the catalytic water conditioner. In other words it might indeed serve as a modest, or very modest, “de-scaler”.

The problem comes when such devices are alleged by some—as is also supported by the inventor of the present invention—to have beneficial effect for much greater distances, and around right angle bends in plumbing, etc. so that a single device may typically serve to condition water for an entire building. The best extant theory of the operation of these devices yet known to the inventor of the present invention is summarized hereinafter. However, for the present moment it is sufficient to understand that these devices, optional in the water system of the present invention, remain controversial circa 2002.

2.4.1 Effects of a Catalytic Water Conditioner

Hard water, scale and the resulting corrosion act to destroy water pipes, plumbing fixtures and appliances. Scale shortens the life of water heaters, dishwashers and washing machines. Hard water scale that forms on bathroom tiles and shower heads, in addition to looking unsightly, can support bacteria growth and corrosion. Even lawns and plants can be affected because scale buildup on surface soil can block water reaching plant roots.

Proponents of catalytic water conditioners—which are, as of year 2002, but a small minority in the United States as judged by dollar volume of industry activity—believe that traditional, chemical, water softeners are not the best solution. Not only are these water softeners costly and inconvenient to maintain, but they introduce sodium into the water supply. Many people don't like the “slick” feeling from the chemically-softened water, and the residue that many perceive to remain on their skin when attempting to rinse off after washing. Concerns have also been voiced about using chemically softened water for drinking and for watering plants.

Chemical water softeners also dump sodium chloride in to the ecosystem: that is why they have been banned in some communities.

Catalytic water conditioners represent an alternative. For over 40 years, catalytic water conditioners have been used by restaurants, industrial companies, power generating utilities, and agriculture. They are used to minimize the effects of hard water scale in diverse applications such as boilers and steam generators, commercial dishwashing machines, ice making machines, car washes, and irrigation systems. They are even used by park districts and golf course operators to protect expensive sprinkler heads and promote better irrigation by breaking down surface soil scale buildup.

Efforts have been made in the past to adapt catalytic water conditioner technology to residential use. Most water conditioners resultant from these efforts (i) proved unable to accommodate the wide range of household water flow rates, (ii) were often much more complicated than necessary and, in accordance that they purportedly supplanted chemical water conditioning, (iii) were exceedingly expensive considering their construction. In the early 1990's corporations with broad experience in industrial and aerospace flow control products entered into the market, and developed more substantial implementations. However, the fully perfected catalytic water softener does not yet exist—including in the embodiment of the present invention.

A catalytic water conditioner can provide a simple, yet effective way to meet the requirements of residential use without special valves or restrictors that can affect water pressure. The result of the catalytic water conditioner is an affordable whole-house water conditioner that is simply installed in the incoming water line. Water is conditioned at all normal residential flow rates.

A catalytic water conditioner prevents calcium deposits. A catalytic water conditioner works to suspend the calcium in the water so it will not scale up or “stick” to pipes and appliances. This extends the life and efficiency of hot water heaters, reverse osmosis units, ice makers, dishwashers, shower heads and other water using equipment.

A catalytic water conditioner removes existing scale. Existing thick scale deposits in plumbing, water heater and fixtures will become softened and eventually removed downstream of a catalytic water conditioner. Heating systems perform more efficiently because of better heat transfer. The cost of electricity and/or gas can be reduced.

A catalytic water conditioner doesn't change water feel or taste. A catalytic water conditioner does not make the water feel “slick” like standard water softener systems do; soap rinses off clean and easy without any persistent residue. It does not add a salty or metallic taste to the water.

A catalytic water conditioner requires no treatment chemicals or salt. When compared to a water softener, a catalytic water conditioner save money on equipment, salt and maintenance. Also, it never wears out.

A catalytic water conditioner simplifies cleaning. Catalytic water conditioners generally reduce the requirements for soaps, detergents and cleansers. Cleaning lime spots and calcium deposits from fixtures, shower doors and tubs is much easier. Dishes come out looking cleaner and brighter. Residue wipes away quickly without the need for solvents and other harsh cleaning products.

A catalytic water conditioner promotes plant growth because plants need good water too. In agricultural applications, catalytic conditioners are actually used to help plants grow faster, healthier, and greener because they are able to absorb more nutrients. Water penetrates deeper into the soil. The need for watering and use of fertilizers is reduced.

A catalytic water conditioner reduces water and soil pollution relative to a chemical water conditioner by decreasing the amount of sodium and other chemicals introduced into the environment.

2.4.2 How a Catalytic Water Conditioner Works

Perhaps the best theory of the operation of a catalytic water conditioner is expounded in the article Catalytic Water Conditioning by Leon Kim, and endorsed by Frank E. Schultz, appearing in WATER PURIFICATION AND CONDITIONING magazine at page 72 et seq., for February, 1987. Notably, this article is not endorsed by the magazine, which takes a “neutral position” in this controversial subject.

Hard water entering a catalytic water conditioner inlet flows across a highly engineered catalyst element. The surface of this catalyst element consists of millions of bi- and tri-metallic junctions similar in geometry to calcium carbonate (Ca CO₂), the dissolved mineral that makes water hard. Through a phenomenon called lattice matching, minerals attach to each other and form crystals. Minerals in solution can also be made to attach to other surfaces with similar lattice patterns. Calcium carbonate temporarily collects and accrues onto these catalyst element junctions. These deposits form microscopic crystals that are less stable, but still attractive to the calcium carbonate still in solution. This process is called nucleation and is familiar to those scientists who work in the areas of semiconductors, physical chemistry and metallurgy. These crystals grow to a size believed to be between 0.0000004″ and 0.000004″, which is too small to be seen with an optical microscope. Difficulty of observation as to what, if anything, is dynamically going on the surface of the catalyst has been, and is, a continuing challenge in the formulation of a theory of the operation of a catalytic water conditioner.

The very small and immature crystals are believed to be flushed off the catalyst surface due to combination of their instability and the shearing force of the flowing water. Billions of these calcium carbonate crystals, or calcite “seeds” are now within the treated water exiting the catalytic water conditioner. These billions of calcite “seeds” appear to be more attractive to dissolved calcium carbonate than those surfaces that do not closely match their geometry, so the surfaces of pipes and other devices using the treated water will suffer in their relative ability to attract calcium carbonate, and their tendency to build scale will be defeated for the duration, and the extent, of flow in which the calcite “seeds” are present. In addition, since these “seeds” also seem to be slightly more attractive to calcium carbonate than the normal hard scale so that, over a period of time, calcium carbonate that has already been deposited as hard scale will slowly be drawn to the “seeds” and then actually removed into the flowing water.

Since the calcium carbonate in the treated “water” is not actually removed, but is only temporarily “converted”, with deposition of the calcium carbonate postponed, full, or even enhanced, scaling might be expected to resume some distance downstream—and this is indeed what is observed, typically after some hundreds of feet of piping. However, most water is typically (i) within a drain, or, (ii) in the case of a recirculating system, back within the supply mains, by this time so that, in any case, detrimental deposition of calcium carbonate scale within the pipes and other appliances of a building is substantially precluded.

If water is withdrawn from the “treated” region and permitted to dry on a surface a small amount of calcium carbonate residue will be present—proving again that the catalytic water conditioner does nothing to remove calcium carbonate from the water. However, this powder does not strongly attach to the surface and, if visible, can be easily wiped off. It does not seem to be, or to form, exactly the same as is the same water taken at the same place from a supply line that does not incorporate a catalytic water conditioner.

In accordance that the calcium carbonate is not extracted from the “treated” water, beneficial mineral content is not lost.

### SUMMARY OF THE INVENTION

The present invention contemplates a portable cleaning and rinsing device using ultrapure water produced in the system by process of reverse osmosis (“RO”). The extension of reverse osmosis (RO) from a stationary system where it may serve, for example, to purify (only) the final rinse water of a car wash—as shown in U.S. Pat. No. 5,413,128 (and others heretofore discussed)—into a completely portable system where, most preferably, not only some, but all necessary cleaning and rinsing water is RO filtered at time of use is, it is respectively suggested, a bit of a “stretch”. Practical implementation of such a system requires the careful attention to details next discussed.

First, the invention is based on the recognition that water purified by reverse osmosis (RO) is not only highly efficacious for spot free rinsing, but—especially as purified to Total Contained Solids (TCS) of less than 20 parts per million (<20 ppm) and more preferably less than 10 parts per million (<10 ppm)—is quite generally an extremely effective solvent for cleaning, even without soap or detergent. Such water is both ultrapure and ultrasoft, and is of a quality more commonly associated with the laboratory use of water as a chemical reagent, or in the cleaning of small precision parts, than the rather more mundane, and much more copious, uses to which water of this extreme high quality is employed by the present invention.

So recognizing that highly purified, <10 ppm TCS, RO water is beneficial for cleaning, the present invention next, second, recognizes that efficiently obtaining this water would best use a triple stage reverse osmosis process. Moreover, when (i) the necessary flow rates—about 3 gpm—and (ii) the necessary gallonage of water used in the washing of cars, motorcycles, boats, houses and like objects—most typically from 10-100 gallons per job, with 10-100 jobs per day—were compared to the RO filtration requirements, it was found that such triple RO filters could be realized, if artfully partitioned and chosen with high performance membranes, at a size and at a weight—normally three membranes filters of about 2½″ diameter by 40″ length each weighing about 34 pounds and containing 2.5″×40″ membranes—besuiting portability.

It was next, third, recognized that if the membranes of the preferred three “high performance”, portable, RO filters were to have desired lives—nominally 3-5 years depending upon use—than pre-filtration must be excellent, and would best be accomplished in plural, and more preferably two, advanced filters. In accordance with the present invention, the preferred two filters are preferably implemented as first, sediment, filter of about 4½″ diameter ×10″length in size containing 5 micron KDF media and a second filter also of about 4½″ d.×10″ l. containing both carbon and KDF media. These two filters are thus realizable at a size suitable for portable R.O. applications.

Next, fourth, it was recognized that the efficient and effective performance of the most preferred two filter stages and the most preferred three reverse osmosis membranae stages would require an input water pressure higher than normal municipal system water pressure of 15-50 p.s.i., and preferably about 150 p.s.i. This requires a motor driven pump so as to boost the input water pressure.

Since the output water pressure for a sprayer cleaner is best boosted to at least 1000 p.s.i., this high pressure seemingly requires a complete second motor driven pump at the output of the RO filters. Alas, two motors driving two pumps of the required capacities typically together consume more than 15-20 amperes a.c. at 100 v.a.c. (7.5 amperes a.c. at 220 v.a.c.), and will often trigger the circuit breakers of normal business and commercial power outlets to which the portable high pressure RO water cleaning and rinsing system of the present invention is desirably plugged. According to (a fifth) recognition of the fact that two motors (as power two pumps) (i) are expensive and (ii) draw more current than may commonly be available, the present invention contemplates a new combination of electric motors and pumps where one single electric motor drives a separate pump at each end of its shaft. One, first, pump serves to boost the input water pressure to, preferably, 150 p.s.i. while the other, second, pump serves to boost the RO output water pressure to, preferably, 1000 p.s.i. The preferred single electric motor consumes about 14 amps at 110 v.a.c. (7 amps at 220 v.a.c.).

Still further engineering choices are made so that the most preferred embodiment of a portable high pressure RO water cleaning and rinsing system of the present invention is a reliable, nearly maintenance free, long-lived, high performance system easily rolled, and transported by vehicle (normally a pickup truck) for effective use on diverse jobs in various environments. For example, the water flow path to, or more preferably from, the filters preferably passes through an anti-scaling unit, and more preferably one of a custom design (as taught herein this specification). For example, the controls of the system are foolproof so as to preclude that the such cut-off of flow to the RO membranes as would induce their failure can occur by operator error. The controls are also completely waterproof, making that the system may suitably be used to wash itself. For example, the frame of the system is preferably made of welded aluminum coated with epoxy powder. The spray wand is selectable to the task at hand, and may optionally mount both un-powered and powered brushes and the like.

1. Theory and Practice of the Present Invention in Using Highly Purified Water in (i) Pure Water Washing and/or “Spotless” Rinsing

The portable water purification system of the present invention is believed to be novel, and is clearly useful, regardless of how sound is the supportive rationale for its existence. The system of the present invention both produces and uses purified water much in much more copious amounts, while simultaneously purifying the water to much higher standards (normally less than 10 ppm, and typically <7 ppm), than has heretofore associated with the mundane washing and rinsing tasks on which the system is normally employed. This requires a quality constructed RO system of some size and cost, certain consumable filtration media and membranes, waste water (from the RO system to drain if not recycled), and electricity. Is it worth it?

A first consideration—to which all others are subservient—is how well the system works—regardless of cost effectiveness—to do its assigned tasks. Needless to say, rinsing with ultrapure ultrasoft water is absolutely spotless, and absolutely no mopping up or other treatment of even mirror surfaces is required. Substantial pools of water will evaporate totally without a visible trace. It is usually the case that a better washing and rinsing job can be done with half the water, in half the time, with the ultrapure and ultrasoft RO water of the present invention than with regular (first-world, potable) municipal water followed by a purified RO water rinse.

It should next be considered that because no impure water is ever used in washing, rinsing with the portable RO system of the present invention may become sort of a redundant task. This is especially true when it is considered that ultrapure pure water is such a good solvent that many polished hard surfaces such as window glass and automotive finishes (which are in good shape) may be, as contaminated only by atmospheric and other environmental contaminants (and not by, for example, paint) can be effectively washed with water alone, and totally without detergent or soap. Indeed, almost all windows can be so washed—totally avoiding visual and chemical contamination of buildings and grounds including landscape plants.

Those vehicles that can be so washed depend upon vehicle type, location, duration since last washing, the state of vehicle's finish, and environmental conditions. However, in the relatively new vehicle population of Southern California enjoying for the most part good and dry roads in arid conditions, it has been found that approximately 85 percent of vehicles can be satisfactorily washed totally without soap or detergent, with a slightly lower percentage being suitably so washed in the winter, or rainy, season.

Needless to say, when soap or detergent is used, only a small quantity is required. The soap or detergent performs marvelously, effectively, and quickly in and with the ultrasoft and ultrapure water.

According to the fact that both washing—with or without soap and detergent—and rinsing are observably fast and effective with ultrapure ultrasoft water, each of time, labor and water are conserved. Most typically a car, by way of example, that is only modestly soiled can be well washed with a total water consumption, including waste water, of less than 10 gallons. At a typical nozzle flow rate of, most commonly, 2 gallons per minute, this means that a car may be washed and rinsed to completion in five (5) minutes. This is very fast by industry standards—even as human cleaning labor may be aided and abetted the often very substantial, and expensive, infrastructure of the automated car wash emporium!

A human being with a wand also arguably does a better and more precise cleaning job with less water, concentrating on the dirty spots (which with the pure water remain substantially visible until removed) and flexibly directing spray under fenders, trim and the like to remove concealed contamination and, where present, road salt.

The cost of electricity for the motor powering the reverse osmosis process, and the pressure washing, is negliable per wash. The 10 gallons of water can be costly, and environmentally costly, but in certain, generally fixed, cleaning yards even this “waste”—which is but slightly elevated in salt content—can be recycled. The total water used is in any case no more than is normally required, and—without, or with a much reduced, addition of chemical agents in the wash—this water is delivered onto surfaces, and possibly eventually to a drain, in better condition than in a standard car wash.

2. A Portable Water-Based Washing/Rinsing System

Therefore, in one of its aspects the present invention is embodied in portable water-based washing/rinsing system.

In its simplest and most elemental expression, the system of the present invention consists of a wheeled trolley, or cart, bearing a reverse osmosis system.

The RO system has several, preferably two, flow-connected pre-filters, preferably one of the sediment (nominally 5 micron) type and one other preferably containing both (i) activated carbon, and (ii) KDF media.

In flow series either upstream or, more preferably, downstream of these filters is optionally, but preferably, placed an antiscaling device. This anti-scaling device is most preferably of original design, consisting substantially of approximately 5 lbs. 50%-50% copper-zinc washers spaced parallel along an approximate 10″ length of #10 brass rod, the washers being separated upon the rod by plastic spacers.

The reverse osmosis system further includes a series-flow-connected plurality of RO membrane filters, and more preferably three such series-flow-connected RO membrane filters each with a membrane having a nominal size of 2½″×40″ and a flow capacity of minimum 2 g.p.m, and nominal 3 g.p.m. (at a 150 p.s.i. input water pressure).

One pump boosts the pressure of the supply water, preferably to more than 130 p.s.i. and more preferably to about 150 p.s.i., before it is applied to the first of the series-flow-connected RO membrane filters. A second pump boosts the pressure of the purified RO water output from a last (i.e., second) one of the series-flow-connected RO filters, preferably to more than 800 p.s.i. and most preferably to 1000 p.s.i. The ratio of waste to purified RO water is preferably 1:2 or less, and is more preferably about ⅓, permitting the first pump to have a nominal pumping capacity of 3 g.p.m and the second pump a nominal capacity of 2 g.p.m.

More important than the size of the two pumps is that each is preferably powered from the same electric motor, and more preferably each is powered by an oppositely-extending shaft end of this one motor. The single motor is of nominal power consumption of 13.5 amperes at 110 v.a.c.; permitting economical operation of the entire portable water-based washing/rinsing system on most normal a.c. wall sockets.

3. A Portable High-Pressure Water Spraying System

In another of its aspects the present invention can be considered to be embodied in a portable high-pressure water spraying system.

As well as the portable wheeled trolley, or cart, or frame, the system includes a complete reverse osmosis and pressure pumping system. Only (i) input water and (ii) power need be connected for the system to function to continuously produce a high-pressure, nominally 1000 p.s.i. spray (or other directed stream) of highly pure, nominally <10 ppm and more commonly <7 ppm Total Dissolved Solids, water. Although soaps, detergents and other chemicals may be added to the system, most cleaning tasks require none, pure water itself being a powerful solvent.

The reverse osmosis and pressure pumping system preferably includes (i) several, nominally two (2), series-flow-connected pre-filters receiving and pre-filtering input water flow-connected to (ii) a first, input-water-pressure-boosting, pump; flow-connected to (iii) several, nominally three (3), series-flow-connected RO membrane filters receiving the pressure-boosted input to produce both waste water, and purified RO water. The purified RO output water is flow-connected to (iv) a second, purified-RO-water-pressure-boosting, pump, which is itself flow-connected to (v) an outlet nozzle for spraying the pressure-boosted purified-RO-water.

The system optionally further includes in service with the several pre-filters an anti-scaling device.

Preferably a single electric motor powers both the first pump and the second pump.

The preferably two (2) pre-filters are most preferably a sediment prefilter that is flow-connected to an activated carbon prefilter.

The first, input-water-pressure-boosting, pump of the reverse osmosis and pressure pumping system preferably boosts the pressure of water input to the plurality of series-flow-connected RO membrane filters to greater than 130 p.s.i., and more preferably to 150 p.s.i.

The series-flow-connected RO membrane filters are preferably each of at least 2 g.p.m. flow capacity, and are more preferably each of at least 1,300 gallons per day flow capacity at 99.4% rejection.

The overall portable high-pressure water spraying system is preferably set to produce greater than 50% purified water and less than 50% waste water, and will more preferably produce greater than 66⅔% purified water and less than 33⅓% waste water from clean input water such as is the standard in U.S. municipalities.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is a diagrammatic perspective view showing a preferred embodiment of a portable high-pressure washing and rinsing system in accordance with the present invention both producing and using ultrapure ultrasoft reverse osmosis water.

FIG. 2 is a prior art graph within which the preferred water purity of the referred embodiment of the present invention may be located.

FIG. 3 is a flow schematic of the preferred embodiment of a portable high-pressure washing and rinsing system in accordance with the present invention previously seen in FIG. 1.

FIG. 4, consisting of FIGS. 4a and 4b, are electrical schematics of the preferred embodiment of a portable high-pressure washing and rinsing system in accordance with the present invention previously seen in FIG. 1.

FIG. 5, consisting of FIGS. 5a and 5b, are exterior and interior views of an anti-scaling device optionally preferably used in the portable high-pressure washing and rinsing system in accordance with the present invention.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

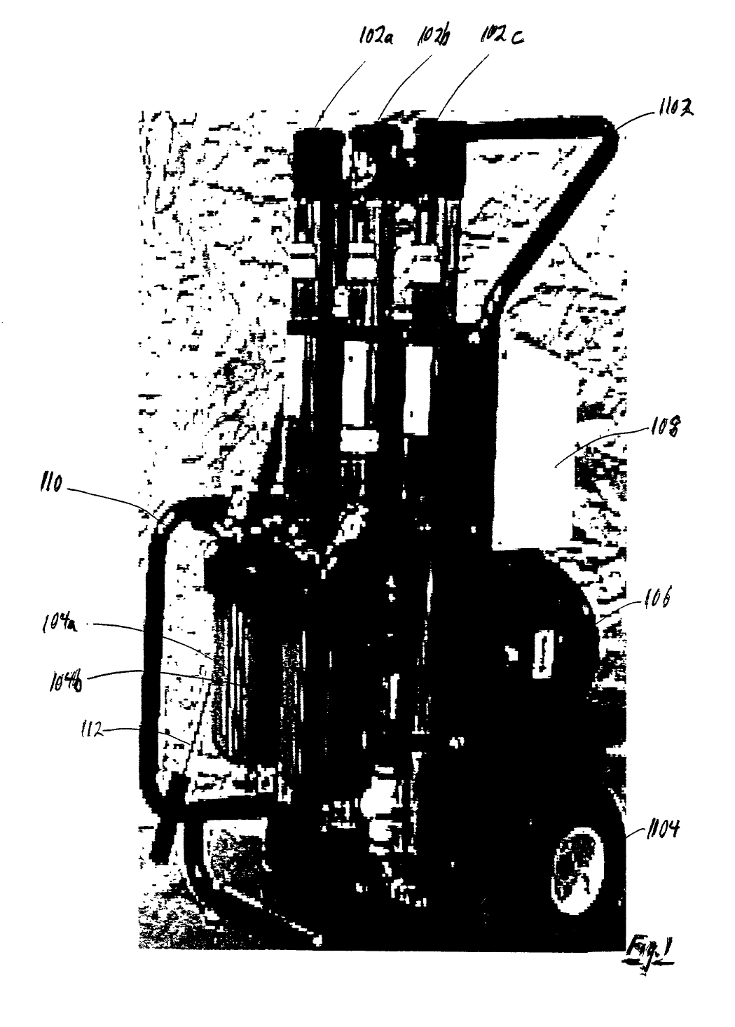

A diagrammatic perspective view showing a preferred embodiment of a portable high-pressure washing and rinsing system 1 in accordance with the present invention is shown in FIG. 1. The system 1 both produces and uses ultrapure ultrasoft reverse osmosis water.

The physically most prominent features of the system 1 are its (i) preferred three reverse osmosis filters 102a-102c, which are commonly wrapped in bright metal, normally chrome, (ii) preferred two pre-filters 104a, 104b, (iii) motor 106, and (iv) control panel 108, all of which are mounted to a cart 110 having a handle 1102 and wheels 1104. Also visible is the spray gun 112 flow connected via a hose 1121. Neither a connection via a hose 2 (not shown) to an external water supply 21 (not shown), nor a connection via a power cord 3 (not shown) to an external source of power 31 (not shown), is shown in FIG. 1.

The cart 110, and the system 1, may be transported, and will rest stably during both non-operation and operation, in both the illustrated vertical and in the horizontal position.

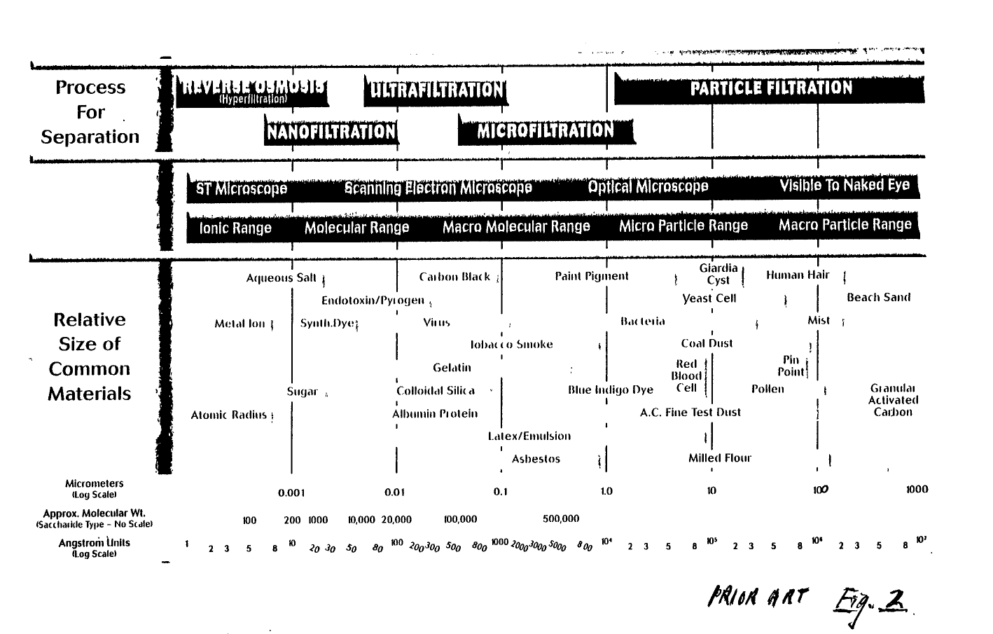

A prior art graph showing the range, and the conventional ways of obtaining, of water of various purity is shown in FIG. 2. (In FIG. 2 note that 1 micron (1×10⁻⁶ meters, or one micrometer)=4×10₋₅ inches=0.00004 inches; and 1 angstrom unit=10⁻¹⁰ meters=10⁻⁴ micrometers.) The reverse osmosis process used by the system 1 of the present invention is the well known means by which water purity of maximum purity may, with an appropriate membrane filter operated at an appropriate pressure (generally higher than municipal water pressure), be obtained. With a properly large and properly configured system, purified water may be obtained at the considerable 2 gallons per minute flow rate (after a 60 second warm-up time) of the preferred embodiment of the system 1 of the present invention.

Referring to the chart of FIG. 1, the system 1 of the present invention uses two large pre-filters 104a, 104b which, as preferably configured as an 104(a) sediment filter flowed by a 104b carbon-KDF filter, remove particulate matter to, respectively, 10 microns and 5 microns. This pre-filtered water is elevated in pressure by the pump 1062 to, most preferably, 150 p.s.i., and passed through, most preferably, three series RO filters each with a membrane type TPC commercially available from, among other sources, R.O. Ultratec, Fallbrook, Calif. as type “ESPA FILM” of, most preferably, 2½″×40″ size. These components will flow 1,300 gallons per day, and 3.3 total gallons per minute consisting of both (1) waste water and (ii) purified water in a ratio of, most typically and most preferably, 2:1, and in any case (of suitable input fresh water) no worse than 1:1. In other words, about 1 gpm goes to the drain, or for recycled recovery, and about 2 gpm of purified water goes through the spray gun 112.

This purified water most typically has no particulate matter greater in size than 0.001 micrometers. Indeed, it has such a small cumulative amount of particulate matter of any size that the evaporation of 1/16 inch of this purified water from upon a mirror surface—a tremendous thickness when it is considered that water this soft and pure will not bead, and flows even on rough surfaces under but the slightest gravitational or wind forces—will not leave a trace visible to the naked eye. Water this pure is “non-spotting” in the extreme: there are virtually no dissolved solids in the water from which spots might be formed. Mechanical removal of this water from a surface is not only not necessary but undesirable: a clean chamois or paper towel will deposit more dirt and fiber than is within the water that it might serve to remove.

A flow schematic of the preferred embodiment of the portable high-pressure washing and rinsing system 1 in accordance with the present invention—previously seen in FIG. 1—is shown in FIG. 2. External water supply fresh (non-salt) water is supplied—most typically under pressure from 10-50 p.s.i. but not necessarily under any pressure at all (i.e., 0 p.s.i. is permissible)—into the suction hose 101. The suction hose 101 is preferably routed directly to the first pre-filter 104a, which is preferably of the sediment type. Output of this pre-filter 104a is routed by line 105 to the second pre-filter 104b which is preferably of a type containing both (i) carbon and (ii) the mixture of high-purity copper-zinc granules, or “KDF”, described in various of U.S. Pat. Nos. 5,951,869, 5,833,859, 5,599,454, 5,510,034, 5,433,856, 5,314,623, 5,275,737, 5,269,932, 5,198,118, 5,135,654, 5,122,274, 6,197,204, 5,837,134 and 5,415,770 and sold by KDF Fluid Treatment, Inc., Michigan, USA.

An optional, but preferable, first pressure gauge 104a2 is mounted to the first pre-filter 104a, and a likewise preferred, but optional, second pressure gauge 104b2 is likewise mounted to the second pre-filter 104b.

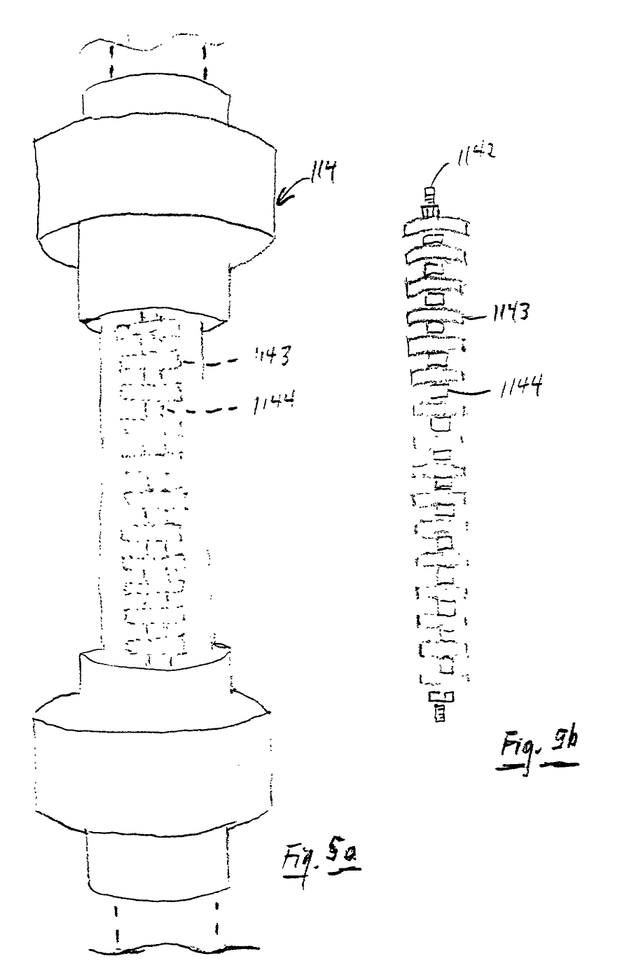

An optional water conditioner, or anti-scaling, device 114 may be located in the line 101 where it is illustrated in phantom line, but is more preferably located in the line 105 between the second pre-filter 104b and the first pump 1062 attached to the shaft of the motor 106 at a first end thereof. The construction, and function, of the anti-scaling device will be further explained in conjunction with FIG. 5.

Pre-filtered water from the second pre-filter 104b as elevated in pressure to, most preferably, 150 p.s.i. is passed from the pump 1062 via line 107 to, in series, RO filters 102a, 102b, 102c. The pressure of this water in the line 107 is preferably readable to the operator of the system 1 on a pressure gauge 10622. Purified RO water from the last RO filter is passed via line 109 to second pump 1064, attached to the shaft of the motor 106 at a second end thereof, to be elevated in pressure to, most preferably, 1000 p.s.i. Waste water from the same last RO filter 102c is passed via line 111 to drain through a pressure regulator valve 116.

Manual adjustment of the pressure regulator valve 116 is the way that a balance of flow through the system 1—some, waste, water to DRAIN and some, purified, water to the spray gun 112—sufficient to obtain the desired purity—preferably less than 10 ppm TDS, and more preferably about 7 ppm TDS for U.S.-municipal-quality source water—is realized. The energization of the motor 106, and the pumping act of its attached pumps 1062 and 1064, is realized by closing the electrical switch 15 visible in FIG. 5. Because the membranes within the RO filters 12a-12c can rupture if there is no flow, the pressure regulator valve can never be turned off so far that there is no water flow to drain, and the system 1 will “leak” some slight water, typically about 1½ gpm, during all periods that it is powered on even when no purified water is being used. However, when the system 1 is first powered on—especially in a new location and/or at a new time of day where and when the input water quality is uncertain—the pressure regulator valve is adjusted to, by establishing a pressure gradient in the RO waste water line 11 to DRAIN, set the balance between the waste, and the product (i.e., the purified) RO water. If necessary, more waste water can, and should, generally be countenanced to achieve the desired purity of the product water. Waste water to product water ratio is not linear with the purity of the input water, and even marginal input water can typically be handled at product to waste water ratios of at least 1:1. More typically the desired purity RO water can be realized with a product to waste water ratio of 2:1 or even higher. (Higher ratios are more desirable for “wasting” less water.)

A practitioner of the reverse osmosis arts will recognize that the “waste” water is not truly waste, but simply input water that is slightly elevated in, most commonly, dissolved salts. This “waste” water can accordingly be collected and cycled through the entire system 1 all over again. However, at some point this becomes self-defeating, and it is better just to let the “waste” water run upon the ground to, perhaps, water the flowers.

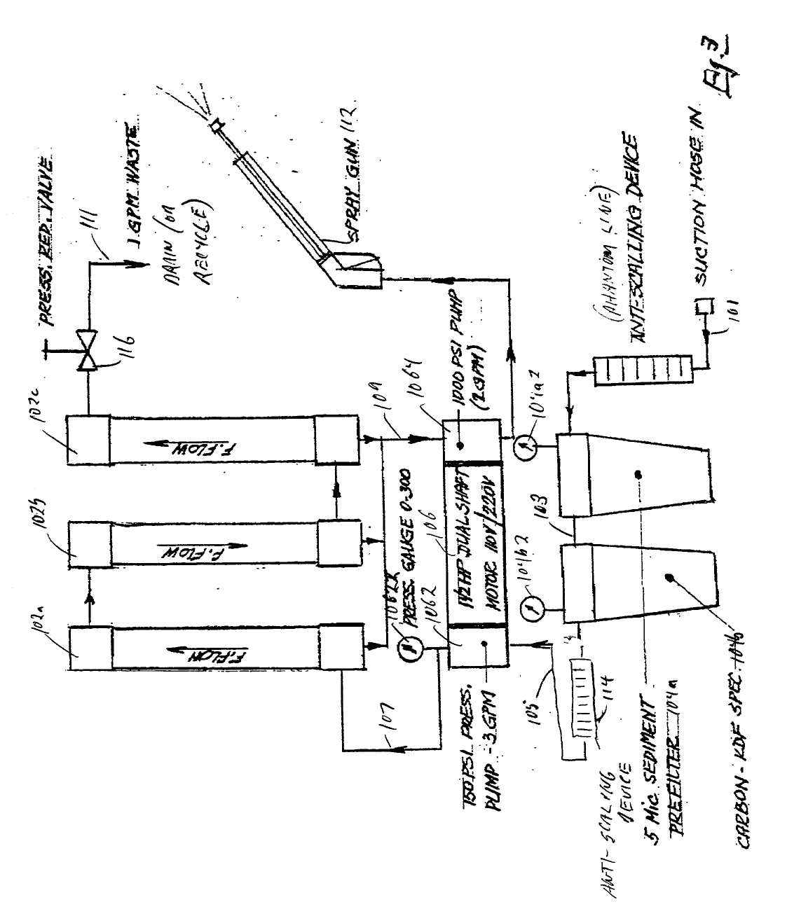

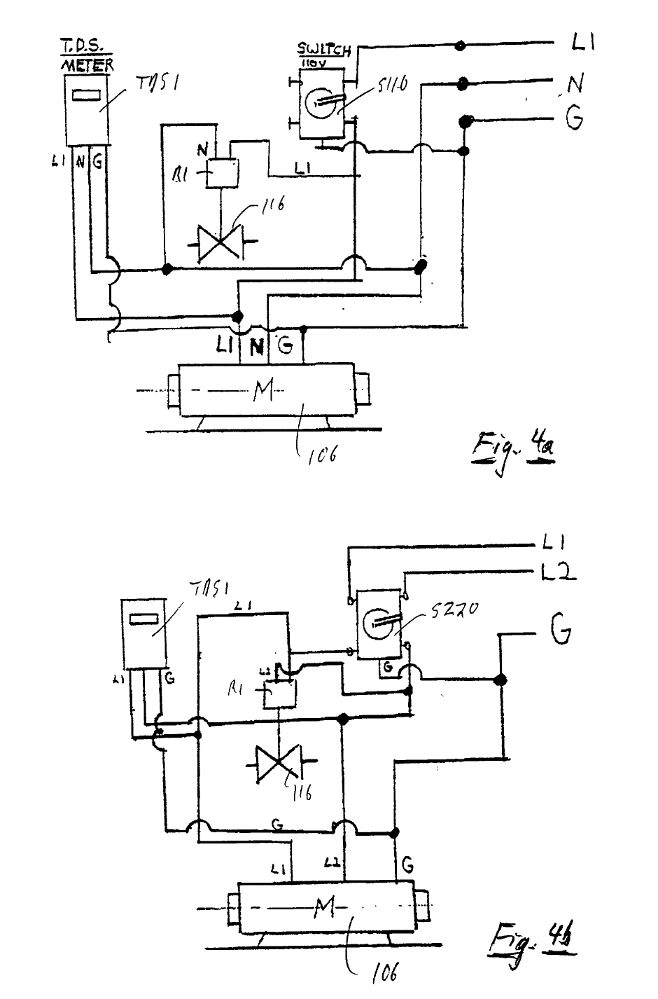

An electrical schematic of the preferred embodiment of a portable high-pressure washing and rinsing system in accordance with the present invention wired for 110 v.a.c. is shown in FIG. 4a, and wired for 220 v.a.c. in FIG. 4b. An input switch S110, S220 is thrown to power on, and power off, the system 1, gating power thereby to both the motor 116 (previously seen in FIGS. 1 and 3), and the total dissolved solids meter TDS1 (part of control assembly 108 seen in FIG. 1). Depending upon the sensed level of total dissolved solids, the solid state relay R1 is opened or closed to move the electrical solenoid valve 116 (also manually adjustable, previously seen in FIG. 3) so as to keep the RO water output at the desired, manually preset, purity level.

FIG. 5, consisting of FIGS. 5a and 5b, is a diagram of an anti-scaling device optionally preferably used in the portable high-pressure washing and rinsing system in accordance with the present invention. The exterior to the anti-scaling device 114, previously seen in FIG. 3, is shown in FIG. 5a while its operative interior section is shown in FIG. 5b. The preferred anti-scaling 114 has an elongate cylindrical housing 1141—preferably made of plastic and, centrally, transparent plastic—as seen in FIG. 5a and the interior assembly shown in FIG. 5b. This preferred interior assembly contains a centrally-located rod 1142, normally made of brass size #10, about which are located a multiplicity of washers 1143, normally 13 such made of 50% copper and 50% zinc, held in spaced parallel relationship by plastic spacers 1144, normally 15 such. The anti-scaling device 114 induces such turbulence in the water, and such other potential effects as are discussed in the background of the invention section of this specification, as substantially precludes the development and deposit of scale, principally calcium chloride, anywhere within the system 1 downstream of the anti-scaling device 114.

In accordance with the preceding explanation, variations and adaptations of the portable high-pressure washing and rinsing system producing and using ultrapure ultrasoft reverse osmosis water in accordance with the present invention will suggest themselves to a practitioner of the reverse osmosis and/or power washing and spraying system arts. For example, the system 1 could be fitted with road-qualified wheels and tires, and towed as a trailer behind a truck or other vehicle.

In accordance with these and other possible variations and adaptations of the present invention, the scope of the invention should be determined in accordance with the following claims, only, and not solely in accordance with that embodiment within which the invention has been taught.

What is claimed is:

1. A portable water washing/rinsing system comprising:
a wheeled trolley; bearing
a reverse osmosis system.

2. The portable water washing/rinsing system according to claim 1 wherein the reverse osmosis system comprises:
a series-flow-connected plurality of RO membrane filters.

3. The portable water washing/rinsing system according to claim 2 wherein the plurality of RO membrane filters comprises:
three series-flow-connected RO membrane filters.

4. The portable water washing/rinsing system according to claim 2 wherein the reverse osmosis system comprises:
a motor with a shaft extending in each of first and second directions;
a first pump attached to the shaft extending in the first direction for boosting the pressure of supply water input to the reverse osmosis system before the water is supplied at boosted pressure to a first one of the series-flow-connected plurality of RO membrane filters; and
a second pump attached to the shaft extending in the second direction for boosting the pressure of the RO water output from a last one of the series-flow-connected plurality of RO filters before this RO water is used for washing.

5. The portable water washing/rinsing system according to claim 4
wherein the first pump boosts the input water pressure a minimum of 100 p.s.i.; and
wherein the second pump boosts the pressure of the RO water output from a last one of the series-connected plurality of RO filters a minimum of 800 p.s.i.

6. The portable water washing/rinsing system according to claim 2 wherein each of the plurality of RO membrane filters has a minimum flow capacity of 2 gpm at 150 p.s.i. input water pressure.

7. The portable water washing/rinsing system according to claim 1 wherein the reverse osmosis system comprises:
two flow-connected pre-filters.

8. The portable water washing/rinsing system according to claim 4 wherein the two pre-filters comprise:
a sediment prefilter; flow-connected to an activated carbon prefilter.

9. The portable water washing/rinsing system according to claim 1 wherein the reverse osmosis system comprises:
an anti-scaling device.

10. A portable high-pressure water spraying system comprising:
a portable wheeled trolley; supporting a reverse osmosis and pressure pumping system including
a plurality of series-flow-connected pre-filters receiving and pre-filtering input water; flow-connected to
a first, input-water-pressure-boosting, pump; flow-connected to
a plurality of series-flow-connected RO membrane filters receiving the pressure-boosted input to produce
(i) waste water, and
(ii) purified RO water flow-connected to
a second, purified-RO-water-pressure-boosting, pump; flow-connected to
an outlet nozzle for spraying the pressure-boosted purified-RO-water.

11. The portable high-pressure water spraying system according to claim 10 wherein the reverse osmosis and pressure pumping system further includes
a single electric motor powering both the first pump and the second pump.

12. The portable high-pressure water spraying system according to claim 10 wherein plurality of series-flow-connected pre-filters of the reverse osmosis and pressure pumping system comprise:
a sediment prefilter; flow-connected to
an activated carbon prefilter.

13. The portable high-pressure water spraying system according to claim 10 wherein first, input-water-pressure-boosting, pump of the reverse osmosis and pressure pumping system boosts the pressure of water input to the plurality of series-flow-connected RO membrane filters to greater than 130 p.s.i.

14. The portable high-pressure water spraying system according to claim 10 wherein plurality of series-flow-connected RO membrane filters of the reverse osmosis and pressure pumping system comprise:
membrane filters each of at least 2 g.p.m. flow capacity.

15. The portable high-pressure water spraying system according to claim 10 wherein plurality of series-flow-connected RO membrane filters of the reverse osmosis and pressure pumping system comprise:
membrane filters each of at least 1,300 gallons per day flow capacity at 99.4% rejection.

14. The portable high-pressure water spraying system according to claim 10 wherein plurality of series-flow-connected RO membrane filters of the reverse osmosis and pressure pumping system comprise:
3 membrane filters each of at least 2 g.p.m. flow capacity.

15. The portable high-pressure water spraying system according to claim 10 wherein the reverse osmosis and pressure pumping system produces greater than 50% purified water and less than 50% waste water.

16. The portable high-pressure water spraying system according to claim 15 wherein the reverse osmosis and pressure pumping system produces greater than 66⅔% purified water and less than 33⅓% waste water.

17. The portable high-pressure water spraying system according to claim 10 wherein the reverse osmosis and pressure pumping system further includes flow connected in series with the plurality of series-flow-connected pre-filters
an anti-scaling device.

18. The portable high-pressure water spraying system according to claim 10 wherein the reverse osmosis and pressure pumping system further includes
a first pressure gauge on the water input to the series-flow-connected plurality of reverse osmosis membrane filters; and
a second pressure gauge on the pressure-boosted purified-RO-water output of the second pump.
